(19) United States
(12) Patent Application Publication
(10) Pub. No.: US 2016/0291219 A1
(43) Pub. Date: Oct. 6, 2016

(54) MIRROR SUBSTRATES, METHODS OF MANUFACTURING THE SAME AND DISPLAY DEVICES INCLUDING THE SAME

(71) Applicant: Samsung Display Co., Ltd, Yongin-si (KR)

(72) Inventors: Dae-Woo LEE, Hwaseong-si (KR); Byoung-Ki KIM, Seoul (KR); Ho-Jin YOON, Hwaseong-si (KR); Yun-Mo CHUNG, Yongin-si (KR)

(21) Appl. No.: 15/047,492

(22) Filed: Feb. 18, 2016

(30) Foreign Application Priority Data
Apr. 1, 2015 (KR) 10-2015-0045943

(51) Int. Cl. G02B 5/08

(52) U.S. Cl. CPC G02B 5/0816; G02B 5/0858

(57) ABSTRACT

A mirror substrate includes a transparent substrate, a plurality of mirror patterns on the transparent substrate, and a mirror layer extending continuously on the plurality of the mirror patterns and the transparent substrate. The mirror layer includes a first mirror layer on the transparent substrate and on the mirror patterns, and a second mirror layer on the first mirror layer. The first mirror layer includes silicon nitride, and the second mirror layer includes silicon oxide.

### CROSS-REFERENCE TO RELATED APPLICATION

This application claims priority under 35 USC §119 to Korean Patent Application No. 10-2015-0045943 filed on Apr. 1, 2015 in the Korean Intellectual Property Office (KIPO), the entire disclosure of which is incorporated by reference herein.

### BACKGROUND

1. Field

Example embodiments relate to mirror substrates, methods of manufacturing the same and display devices including the same. More particularly, example embodiments relate to mirror substrates having a plurality of mirror patterns, methods of manufacturing the same and display devices including the same.

2. Description of the Related Art

Recently, a display device, e.g., an organic light emitting display (OLED) device or a liquid crystal display (LCD) device having a mirror property together with an image display property are being researched.

Layer structures or patterns having a reflective property may be inserted to the display device so as to realize the mirror property. However, a manufacture process or a display quality may be affected adversely due to an implementation of the mirror property.

### SUMMARY

Example embodiments provide a mirror substrate having improved manufacture efficiency.

Example embodiments provide a method of manufacturing the mirror substrate.

Example embodiments provide a display device including the mirror substrate.

According to example embodiments, there is provided a mirror substrate. The mirror substrate may include a transparent substrate, a plurality of mirror patterns on the transparent substrate, and a mirror layer extending continuously on the plurality of the mirror patterns and the transparent substrate. The mirror layer may include a first mirror layer on the transparent substrate and the mirror patterns, and a second mirror layer on the first mirror layer. The first mirror layer may include silicon nitride, and the second mirror layer may include silicon oxide.

In example embodiments, the mirror patterns may include a metal.

In example embodiments, each of the mirror patterns may include a dielectric material, and may include a first mirror pattern and a second mirror pattern sequentially disposed on the transparent substrate.

In example embodiments, the first mirror pattern may include silicon nitride, and the second mirror pattern may include silicon oxide.

In example embodiments, the transparent substrate may be divided into a first region and a second region. The plurality of the mirror patterns may be regularly arranged throughout the first region and the second region. The mirror layer may extend commonly and continuously on the first region and the second region.

According to example embodiments, there is provided a method of manufacturing a mirror substrate. In the method, a transparent substrate including a first region and a second region may be prepared. Mirror patterns distributed throughout the first region and the second region of the transparent substrate may be formed. A first mirror layer may be formed on surfaces of the transparent substrate and the mirror patterns. The first mirror layer may include silicon nitride. A second mirror layer may be formed on the first mirror layer. The second mirror layer may include silicon oxide. A sealing member may be formed between the first region and the second region such that the sealing member may be in contact with the second mirror layer.

In example embodiments, in the formation of the mirror patterns, a metal layer may be formed on the transparent substrate. The metal layer may be patterned.

In example embodiments, in the formation of the mirror patterns, a first dielectric layer including silicon nitride may be formed on the transparent substrate. A second dielectric layer including silicon oxide may be formed on the first dielectric layer. The second dielectric layer and the first dielectric layer may be patterned.

In example embodiments, the first mirror layer may be thinner than each of the first dielectric layer and the second dielectric layer, and the second mirror layer may be thinner than each of the first dielectric layer and the second dielectric layer.

In example embodiments, the first mirror layer and the second mirror layer may be formed continuously throughout the first region and the second region.

According to example embodiments, there is provided a display device. The display device may include a display substrate, a display unit on the display substrate, a mirror substrate facing the display substrate with respect to the display unit, and a sealing member encapsulating the display unit between the display substrate and the mirror substrate. The mirror substrate may include a transparent substrate, a plurality of mirror patterns on the transparent substrate, and a mirror layer extending continuously on the plurality of the mirror patterns and the transparent substrate. The mirror layer may include a first mirror layer and a second mirror layer sequentially stacked on the transparent substrate and the mirror pattern. The first mirror layer may include silicon nitride and the second mirror layer may include silicon oxide. The sealing member may be in contact with the second mirror layer.

In example embodiments, the mirror patterns may include a metal.

In example embodiments, each of the mirror patterns may include a silicon nitride pattern and a silicon oxide pattern sequentially stacked on the transparent substrate.

In example embodiments, the display unit may include an emitting region and a non-emitting region. The emitting region may overlap a portion of the mirror layer between neighboring ones of the mirror patterns. The non-emitting region may overlap a stacked structure including the mirror layer and each of the mirror patterns.

In example embodiments, the stacked structure may have an oxide-nitride-oxide-nitride structure or an oxide-nitride-metal structure.

In example embodiments, the emitting region may include an organic emitting layer or a liquid crystal layer.

In example embodiments, the transparent substrate may be divided into a first region and a second region by the sealing member, and the first region may overlap the display unit. The mirror patterns and the mirror layer may be arranged throughout the first region and the second region.

In example embodiments, the sealing member may include an adhesive resin material.

In example embodiments, the mirror layer may be thinner than each of the mirror patterns.

### BRIEF DESCRIPTION OF THE DRAWINGS

Example embodiments will be more clearly understood from the following detailed description taken in conjunction with the accompanying drawings. FIGS. 1 to 14 represent non-limiting, example embodiments as described herein:

FIG. 1 is a cross-sectional view illustrating a mirror substrate in accordance with example embodiments.

FIG. 2 is a cross-sectional view illustrating a mirror substrate in accordance with some example embodiments.

FIGS. 3, 4, 5, and 6 are cross-sectional views illustrating a method of manufacturing a mirror substrate in accordance with example embodiments.

FIGS. 7, 8, 9, and 10 are cross-sectional views illustrating a method of manufacturing a mirror substrate in accordance with some example embodiments.

FIG. 11 is a schematic cross-sectional view illustrating a display device in accordance with example embodiments.

FIG. 12 is a partial enlarged view of a portion indicated as “A” in FIG. 11.

FIG. 13 is a schematic cross-sectional view illustrating a display device in accordance with some example embodiments.

FIG. 14 is a partial enlarged view of a portion indicated as “A” in FIG. 13.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

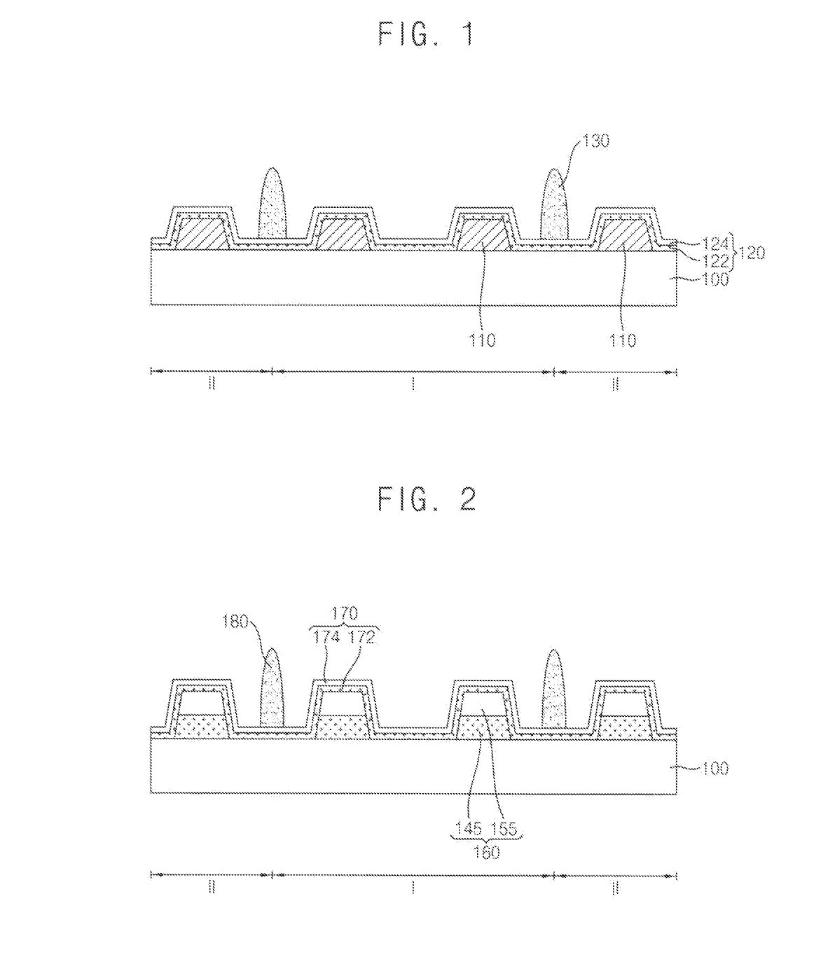

FIG. 1 is a cross-sectional view illustrating a mirror substrate in accordance with example embodiments.

Referring to FIG. 1, the mirror substrate may include a mirror pattern 110 on a transparent substrate 100, and a mirror layer 120 covering the mirror pattern 110.

The transparent substrate 100 may be divided into a first region I and a second region II. The first region I may overlap pixel regions of a display device, e.g., when the mirror substrate is provided as an encapsulation substrate of the display device. The second region II may be provided as a margin region for forming an alignment key and may comprise a sealing member 130.

In example embodiments, as illustrated in FIG. 1, the first region I and the second region II may be divided by the sealing member 130. The sealing member 130 may have a ring shape or a column shape surrounding the first region I. A region outside of the sealing member 130 may be defined as the second region II.

For example, a pad connected to a driving circuit of the display device and/or a flexible printed circuit (FPC) may be placed at a peripheral region from the sealing member 130.

The transparent substrate 100 may include, e.g., a glass substrate or a transparent plastic substrate. The sealing member 130 may include an adhesive material such as a silicone-based material, an epoxy-based material, or the like. However, the sealing member 130 may include various materials capable of absorbing or blocking external atmosphere and/or moisture.

The mirror pattern 110 may be arranged throughout the first region I and the second region II of the substrate 100. For example, a plurality of the mirror patterns 110 may be arranged in, e.g., a grid shape, a line shape, a mesh shape, or in the shape of a plurality of islands.

The mirror pattern 110 may include a material having a high reflectivity. In example embodiments, the mirror pattern 110 may include a metal such as aluminum (Al), chromium (Cr), copper (Cu), silver (Ag), titanium (Ti), tantalum (Ta), molybdenum (Mo), tungsten (W), etc. The mirror pattern 110 may have a single metal layered structure. In some embodiments, the mirror pattern 110 may have, e.g., a double-layered structure or a triple-layered structure which includes a plurality of different metal layers.

As described above, when the mirror substrate serves as the encapsulation substrate of the display device, the mirror pattern 110 may overlap a region except for an emitting region among the pixel region (e.g., the mirror pattern 110 may overlap a non-emitting region). In this case, an area between the neighboring mirror patterns 110 of the mirror substrate may overlap the emitting region of the pixel region in the display device.

In some example embodiments, the mirror pattern 110 disposed in the second region II may serve as the alignment key utilized while, e.g., forming the sealing member 130 or encapsulating the display device.

The mirror layer 120 may be formed on an upper surface of the transparent substrate to cover surfaces of the mirror patterns 110. In example embodiments, the mirror layer 120 may extend commonly and continuously both on the first and second regions I and II of the transparent substrate 100.

In example embodiments, the mirror layer 120 may have a multi-stacked structure including a first mirror layer 122 and a second mirror layer 124. The first mirror layer 122 may be in contact with the upper surface of the transparent substrate 100 and the surfaces of the mirror patterns 110. The second layer 124 may be stacked on the first mirror layer 122.

In some embodiments, the first mirror layer 122 may include silicon nitride (SiNx), and the second mirror layer 124 may include silicon oxide (SiOx).

The mirror layer 120 may have a double-layered structure as illustrated in FIG. 1. However, the mirror layer 120 may have a triple-layered structure or a quadruple-layered structure. Therefore, the mirror layer 120 may have a predetermined reflectivity due to a change of refractive index therein. In some embodiments, the reflectivity of the mirror layer 120 may be less than the reflectivity of the mirror pattern 110.

For example, a portion of the mirror layer 120 between the mirror patterns 110 neighboring in the first region I may overlap the emitting region of the display device.

The sealing member 130 may be placed at a boundary portion between the first region I and the second region II. The sealing member 130 may be formed on the mirror layer 120. In example embodiments, the sealing member 130 may be in contact with the second mirror layer 124 including silicon oxide.

The second mirror layer 124 may include silicon oxide which may be chemically stable even when being in contact with, e.g., an adhesive resin material included in the sealing member 130. In example embodiments, the mirror layer 120 may be easily formed conformally on the transparent substrate 100 and the mirror patterns 110, and the sealing member 130 may be formed on the second mirror layer 124, so that a process for manufacturing the mirror substrate may be simplified.

Further, the first mirror layer 122 including silicon nitride which may have an improved buffer property, e.g., a moisture-resistant property, may be in contact with the transparent substrate 100 and the mirror patterns 110. Therefore, stability from external atmosphere and moisture may be improved.

FIG. 2 is a cross-sectional view illustrating a mirror substrate in accordance with some example embodiments. The mirror substrate of FIG. 2 may have structures and/or constructions substantially the same as or similar to those of the mirror substrate of FIG. 1 except for a structure of a mirror pattern. Thus, detailed descriptions on repeated elements and/or structures are omitted herein.

Referring to FIG. 2, a mirror pattern 160 included in the mirror pattern may have a multi-stacked structure including a plurality of different materials. For example, the mirror pattern 160 may include a first mirror pattern 145 and a second mirror pattern 155.

In some embodiments, the first mirror pattern 145 may include silicon nitride, and may be in contact with an upper surface of a transparent substrate 100. The second mirror pattern 155 may include silicon oxide, and may be disposed on the first mirror pattern 145.

A mirror layer 170, as also illustrated with reference to FIG. 1 (see mirror layer 120 in FIG. 1), may include a first mirror layer 172 and a second mirror layer 174, and may extend continuously along surfaces of the mirror patterns 160 and the upper surface of the transparent substrate 100 between the neighboring mirror patterns 160 throughout first and second regions I and II.

The first mirror layer 172 may include silicon nitride, and may be in contact with an upper surface of the second mirror pattern 155 including silicon oxide. The second mirror layer 174 may include silicon oxide, and may be in contact with a sealing member 180 between the first region I and the second region II.

In some embodiments, when the mirror substrate serves as an encapsulation substrate of a display device, an emitting region of the display device may overlap a portion of the mirror substrate between the mirror patterns 160 in the first region I. A non-emitting region of the display device may overlap the mirror pattern 160 in the first region I. Thus, the non-emitting region may overlap a structure including the second mirror layer 174, the first mirror layer 172, the second mirror pattern 155 and the first mirror pattern 145, in which different materials may be alternately stacked. Therefore, a reflective property may be prevalent at the non-emitting region so that a mirror property may be realized therein.

The mirror pattern 160 may have a double-layered structure as illustrated in FIG. 2. However, the mirror pattern 160 may have, e.g., a triple-layered structure or a quadruple-layered structure. For example, the mirror pattern may further include an additional pattern including silicon oxynitride.

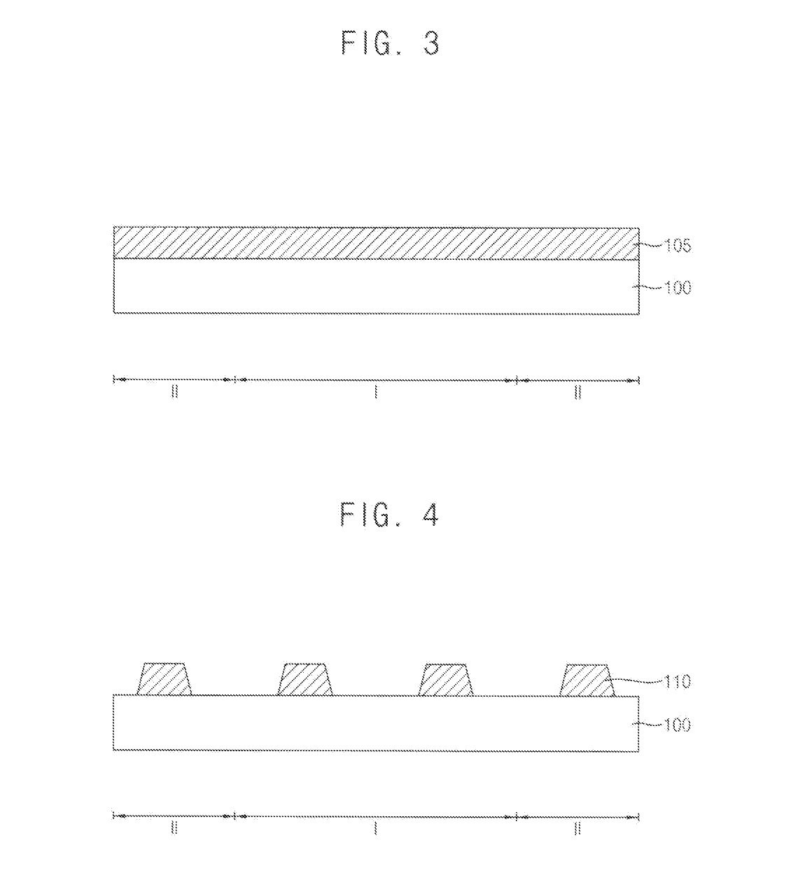

FIGS. 3 to 6 are cross-sectional views illustrating a method of manufacturing a mirror substrate in accordance with example embodiments. For example, FIGS. 3 to 6 illustrate a method of manufacturing the mirror substrate of FIG. 1.

Referring to FIG. 3, a metal layer 105 may be formed on a transparent substrate 100.

For example, a glass substrate or a transparent plastic substrate may be used as the transparent substrate 100. The transparent substrate 100 may be divided as a first region I and a second region II. The first region I and the second region II may correspond to a central portion and a peripheral portion, respectively, of the transparent substrate 100.

The metal layer 105 may be formed of, e.g., Al, Cr, Cu, Ag, Ti, Ta, Mo, W, or the like. These may be used alone or in a combination thereof. The metal layer 105 may be formed by, e.g., a sputtering process, a physical vapor deposition (PVD) process, an atomic layer deposition (ALD) process, a chemical vapor deposition (CVD) process, etc.

Referring to FIG. 4, the metal layer 105 (see FIG. 3) may be patterned by, e.g., a photo-lithography process, to form a mirror pattern 110.

For example, a plurality of the mirror patterns 110 may be formed in a grid arrangement, a mesh arrangement or an arrangement including a plurality of islands through the first and second regions I and II of the transparent substrate 100.

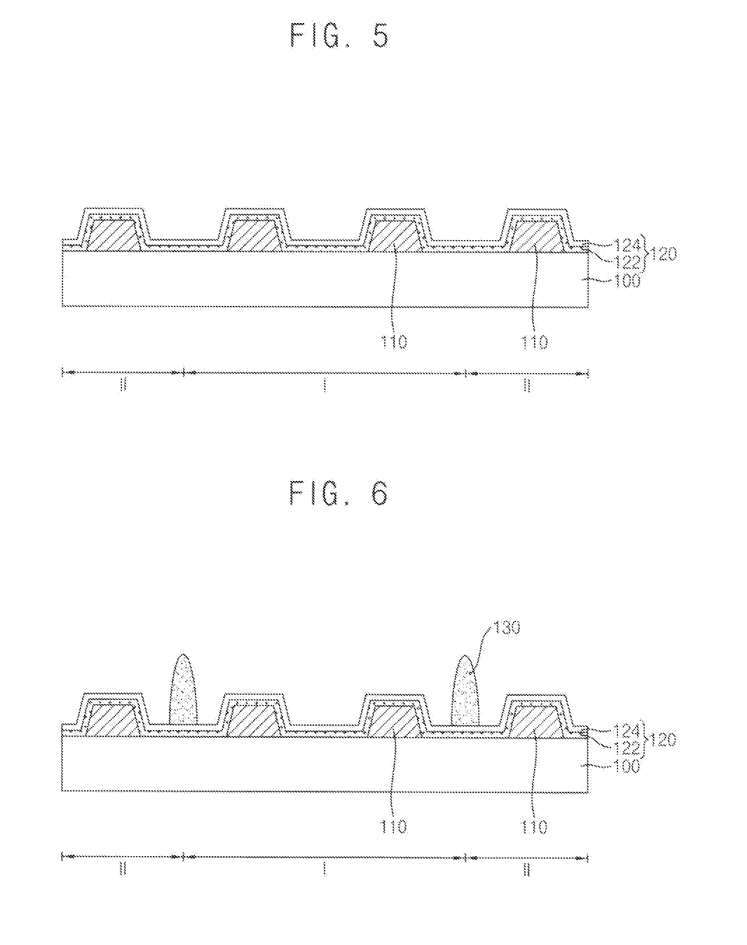

Referring to FIG. 5, a first mirror layer 122 and a second mirror layer 124 may be sequentially formed on an upper surface of the transparent substrate 100 and surfaces of the mirror patterns 110. Accordingly, a mirror layer 120 having a double-layered structure may be formed. A thickness of the mirror layer 120 may be less than a thickness of the metal layer 105 illustrated in FIG. 3.

In example embodiments, each of the first mirror layer 122 and the second mirror layer 124 may cover the mirror patterns 110 and extend continuously and conformally on the first and second regions I and II of the transparent substrate 100.

In example embodiments, the first mirror layer 122 and the second mirror layer 124 may be formed of silicon nitride layer and silicon oxide layer, respectively. In this case, the first mirror layer 122 may cover a substantially whole upper surface of the transparent substrate 100, and may serve as a buffer layer or a barrier layer for blocking moisture or oil from an external environment.

The first and second mirror layers 122 and 124 may, for example, be formed by a CVD process, a plasma enhanced CVD (PECVD) process, an ALD process, a thermal evaporation process, a vacuum deposition process, etc.

Referring to FIG. 6, a sealing member 130 may be formed at a boundary between the first region I and the second region II.

For example, the sealing member may be formed using an adhesive resin material such as an epoxy resin or a silicone resin by a printing process or a coating process.

In example embodiments, the sealing member 130 may be formed directly on a surface of the second mirror layer 124. The second mirror layer 124 may include silicon oxide that may be chemically and mechanically stable with respect to the adhesive resin material. Thus, the second mirror layer may be formed continuously, and the sealing member 130 may be formed directly on the silicon oxide layer of the second mirror layer 124. Thus, a patterning process of the mirror layer 120 may not be required for the formation of the sealing member 130 so that the mirror layer 120 may be formed on the substantially whole upper surface of the transparent substrate 100. Therefore, a patterning process for partially removing the second mirror layer may be omitted. Thus, a process time and a process cost for the mirror substrate may be reduced.

In some embodiments, the mirror pattern formed in the second region II may serve as an alignment key for the formation of the sealing member 130.

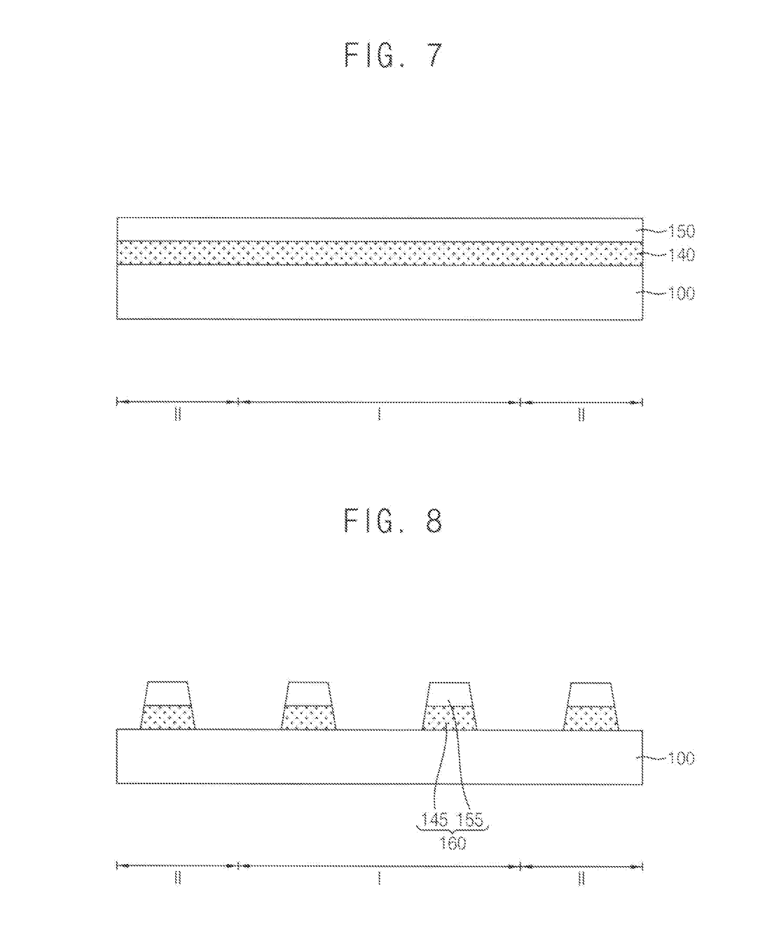

FIGS. 7 to 10 are cross-sectional views illustrating a method of manufacturing a mirror substrate in accordance with some example embodiments. For example, FIGS. 7 to 10 illustrate a method of manufacturing the mirror substrate of FIG. 2. Detailed descriptions on processes and materials substantially the same as or similar to those illustrated with reference to FIGS. 3 to 6 are omitted herein.

Referring to FIG. 7, a first dielectric layer 140 and a second dielectric layer 150 may be formed on a transparent substrate 100. The first and second dielectric layers 140 and 150 may be formed throughout first and second regions I and II of the transparent substrate 100.

In example embodiments, the first dielectric layer 140 and the second dielectric layer 150 may be formed of silicon nitride and silicon oxide, respectively. For example, the first and second dielectric layers 140 and 150 may be formed by a CVD process, a PECVD process, an ALD process, a thermal evaporation process, a vacuum deposition process, etc.

In some embodiments, an additional dielectric layer including, e.g., silicon oxynitride may be further formed between the first dielectric layer 140 and the second dielectric layer 150.

Referring to FIG. 8, the first and second dielectric layers 140 and 150 may be patterned by, e.g. a photo-lithography process. Accordingly, a mirror pattern 160 including a first mirror pattern 145 and a second mirror pattern 155 sequentially formed on an upper surface of the transparent substrate 100 may be obtained.

For example, a plurality of mirror patterns 160 may be formed in a regular or periodic arrangement throughout the first and second regions I and II of the transparent substrate 100.

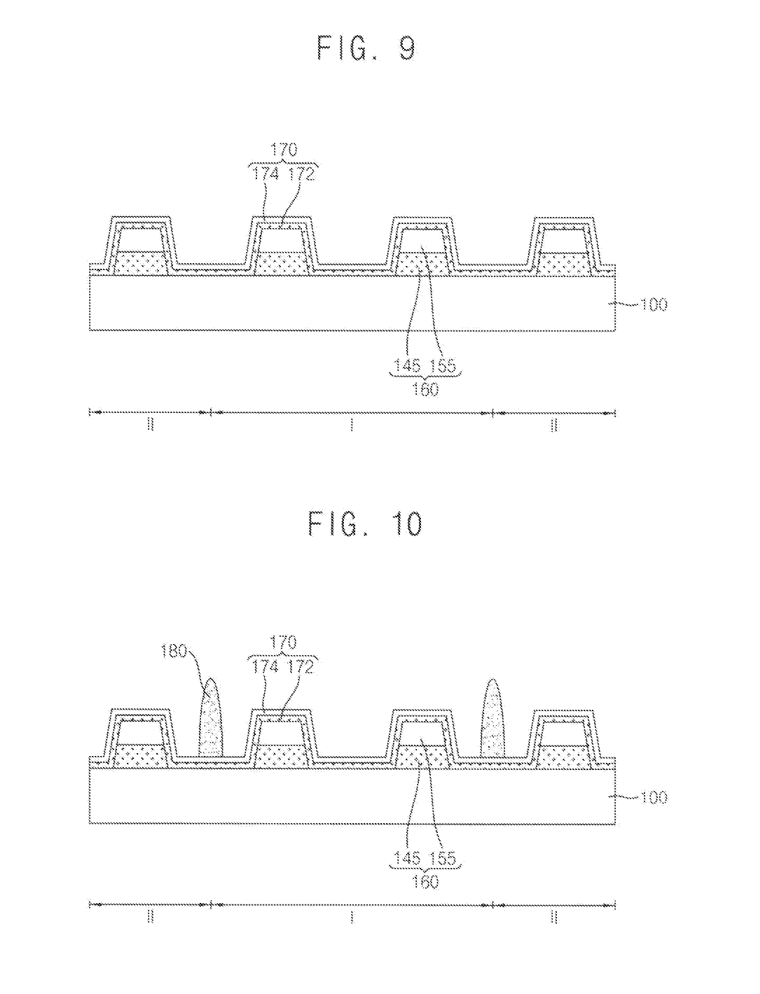

Referring to FIG. 9, a process substantially the same as or similar to that illustrated with reference to FIG. 5 may be performed to form a first mirror layer 172 and a second mirror layer 174 sequentially on the upper surface of the transparent substrate 100 and surfaces of the mirror patterns 160. Accordingly, a mirror layer 170 covering the mirror patterns 160 may be formed continuously throughout the first and second regions I and II of the transparent substrate 100.

In example embodiments, the first mirror layer 172 and the second mirror layer 174 may be formed of silicon nitride and silicon oxide, respectively.

Referring to FIG. 10, and as also illustrated with reference to FIG. 6 (see sealing member 130 of FIG. 6), a sealing member 180 may be formed at a boundary between the first region I and the second region II, and may be in contact with the second mirror layer 174.

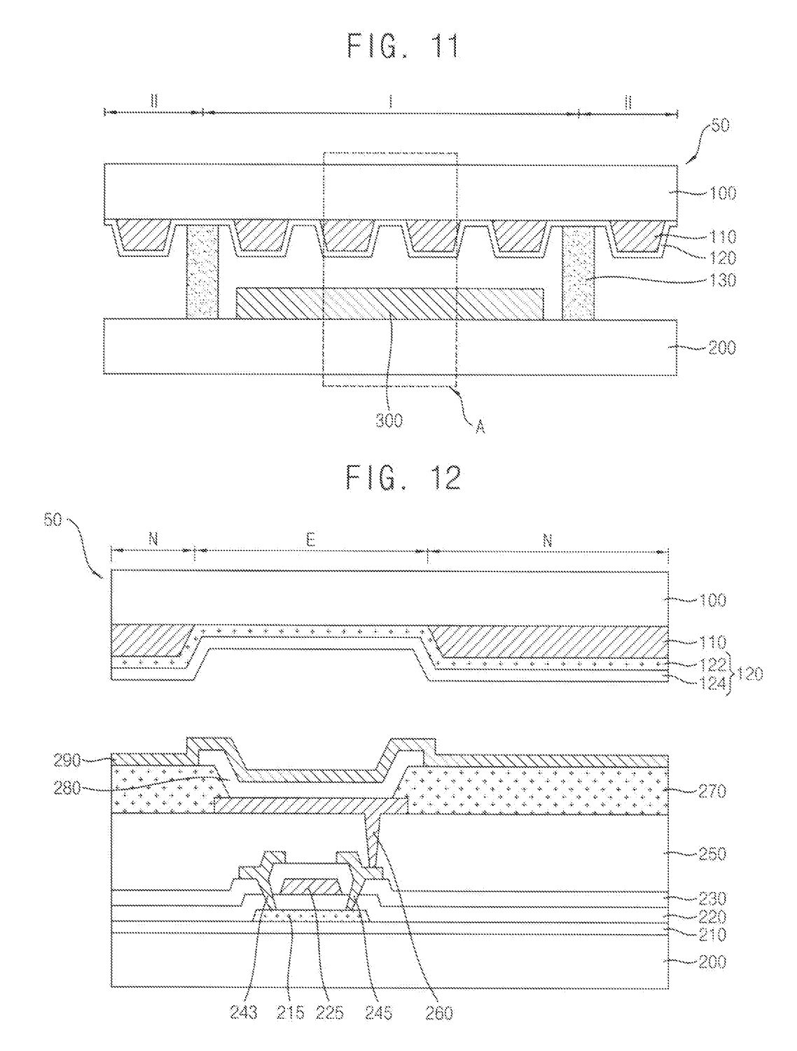

FIG. 11 is a schematic cross-sectional view illustrating a display device in accordance with example embodiments. FIG. 12 is a partial enlarged view of a portion indicated as “A” in FIG. 11.

Referring to FIG. 11, the display device may include a display unit 300 disposed on a display substrate 200, and a mirror substrate 50 facing the display substrate 200 with respect to the display unit 300.

In example embodiments, the mirror substrate 50 may have structures and/or constructions substantially the same as or similar to those illustrated with reference to FIG. 1. As described above, the mirror substrate 50 may be divided into a first region I and a second region II, and may include mirror patterns 110 on an opposing surface of a transparent substrate 100 relative to the display substrate 200, and a mirror layer 120 covering the mirror patterns 110. The mirror layer 120 may be formed conformally and continuously throughout the first and second regions I and II of the transparent substrate 100 to cover the mirror patterns 110.

A sealing member 130 may be interposed between the transparent substrate 100 and the display substrate 200 such that the display unit 300 may be encapsulated. Thus, the mirror substrate 50 may substantially serve as an encapsulation substrate. The sealing member 130 may be in contact with a mirror layer 120 of the mirror substrate 50 between the first region I and the second region II to protect the display unit 300. The display unit 300 may overlap the first region I of the mirror substrate 50, and a peripheral circuit such as a driving circuit or a FPC connecting pad may be disposed on a portion of the display substrate 200 overlapping the second region II.

Referring to FIG. 12, the display unit 300 may include a switching device on the display substrate 200, and a display structure electrically connected to the switching device.

The switching device may include, e.g., a thin film transistor (TFT) including an active pattern 215, a gate insulation layer 220, a gate electrode 225, a source electrode 243 and a drain electrode 245. The display structure may include, e.g., a first electrode 260, a display layer 280 and the second electrode 290.

The display substrate 200 may include, e.g., a glass substrate, a transparent plastic substrate or a flexible plastic substrate.

A barrier layer 210 may be formed on an upper surface of the display substrate 200. Moisture penetrating through the display substrate 200 may be blocked by the barrier layer 210, and impurity diffusion between the display substrate 200 and structures thereon may be also blocked by the barrier layer 210.

For example, the barrier layer 210 may include silicon oxide, silicon nitride, or silicon oxynitride. These may be used alone or in a combination thereof. In an embodiment, the barrier layer 210 may have a multi-layered structure including a silicon oxide layer and a silicon nitride layer.

The active pattern 215 may include a silicon compound such as polysilicon. In some embodiments, the active pattern 215 may include an oxide semiconductor such as indium gallium zinc oxide (IGZO), zinc tin oxide (ZTO), or indium tin zinc oxide (ITZO). For example, an active layer including the silicon compound or the oxide semiconductor may be formed by a sputtering process, and then may be patterned by a photo-lithography process.

The gate insulation layer 220 may be formed on the barrier layer 210, and cover the active pattern 215. The gate insulation layer 220 may include silicon oxide, silicon nitride and/or silicon oxynitride. The gate insulation layer 220 may have a multi-layered structure including a silicon oxide layer and a silicon nitride layer.

The gate electrode 225 may be formed on the gate insulation layer 220, and may be superimposed over the active pattern 215. For example, a first conductive layer may be formed on the gate insulation layer 220, and may be patterned by a photo-lithography process to form the gate electrode 225. The first conductive layer may be formed of a metal such as Al, Ag, W, Cu, Mo, Ti, Ta, Cr, etc., or a nitride thereof by a sputtering process or an ALD process. The first conductive layer may be formed as a multi-layered structure such as an Al/Mo structure or a Ti/Cu structure.

In some embodiments, a scan line may be also formed from the first conductive layer. The gate electrode 225 may diverge from the scan line.

In some embodiments, an ion-implantation process may be performed using the gate electrode 225 as an implantation mask such that a source region and a drain region may be formed at both ends of the active pattern 215. A portion of the active pattern 215 between the source and drain regions, which may overlap the gate electrode 225, may be defined as a channel region through which a charge may be moved or transferred.

An insulating interlayer 230 may be formed on the gate insulation layer 220, and may cover the gate electrode 225. The insulating interlayer 230 may include silicon oxide, silicon nitride and/or silicon oxynitride. The insulating interlayer 230 may have a multi-layered structure including a silicon oxide layer and a silicon nitride layer.

The source electrode 243 and the drain electrode 245 may extend through the insulating interlayer 230 and the gate insulation layer 220 to be in contact with the active pattern 215. The source electrode 243 and the drain electrode 245 may be in contact with the source region and the drain region, respectively, of the active pattern 215.

For example, the insulating interlayer 230 and the gate insulation layer 220 may be partially etched to form contact holes through which the active pattern 215 may be exposed. A second conductive layer filling the contact holes may be formed on the insulating interlayer 230, and may be patterned by a photo-lithography process to form the source electrode 243 and the drain electrode 245. The second conductive layer may be formed from a material and a process substantially the same as or similar to those for the first conductive layer.

In some embodiments, a data line may be also formed from the second conductive layer. In this case, the source electrode 243 may diverge from the data line.

The TFT may be formed in each pixel of the display unit by the processes as described above. In some embodiments, at least two TFTs and a capacitor may be formed in each pixel.

A via insulation layer 250 may be formed on the insulating interlayer 230, and may cover the source and drain electrodes 243 and 245. The via insulation layer 250 may be formed using an organic material such as polyimide, an epoxy resin, an acrylate-based resin, or polyester by a spin coating process or a slit coating process. The via insulation layer 250 may also serve as a planarization layer of the display unit 300.

The display structure may be formed on the via insulation layer 250.

The first electrode 260 may extend through the via insulation layer 250, and may be electrically connected to the drain electrode 245. For example, the via insulation layer 250 may be partially etched to form a via hole through which the drain electrode 245 may be exposed. A third conductive layer sufficiently filling the via hole may be formed on the via insulation layer, and may be patterned by a photo-lithography process to form the first electrode 260.

The first electrode 260 may serve as an anode or a pixel electrode of the display unit 300, and may be formed per each pixel included in the display unit 300.

The third conductive layer may be formed from a material and a process substantially the same as or similar to those for the first conductive layer. In some embodiments, the third conductive layer may be formed of a transparent conductive layer such as indium tin oxide (ITO), indium zinc oxide (IZO), zinc oxide, indium oxide, etc.

A pixel defining layer (PDL) 270 may be formed on the via insulation layer 250 to cover a peripheral portion of the first electrode 260. For example, the PDL 270 may be formed using a photosensitive organic material by exposure and developing processes. Alternatively, the PDL 270 may be formed of a silicon-based inorganic material by a photo-lithography process.

In example embodiments, an area of the first electrode 260 exposed by the PDL 270 may substantially correspond to an emitting region of the each pixel.

The display layer 280 may be formed on the first electrode 260 and the PDL 270. In example embodiments, the display layer 280 may include an organic light emitting material, and the display device may be provided as an OLED device. In this case, a hole transport layer (HTL) and an electron transport layer (ETL) may be further formed under the display layer 280 and on the display layer 280, respectively.

The display layer 280 may be formed by individually printing the organic light emitting material at the each pixel. The HTL and the ETL may be formed at the each pixel, or may be formed commonly at a plurality of the pixels.

In some embodiments, a liquid crystal material may be used for the display layer 280. In this case, the display device may be provided as an LCD device.

The second electrode 290 may be formed on the PDL 270 and the display layer 280. In some embodiments, the second electrode 290 may serve as a common electrode formed on the plurality of the pixels. The second electrode 290 may also serve as a cathode of the display unit 300.

The second electrode 290 may be formed by a depositing a metal or a transparent conductive material as mentioned above through, e.g., an open mask.

As described above, the display unit 300 may be formed on the display substrate 200, and the mirror substrate 50 may be formed on the display substrate 200 using the sealing member 130 such that the mirror substrate 50 and the display substrate 200 may face each other. In some embodiments, the mirror pattern 110 formed in the second region II may serve as an alignment key for the mirror substrate 50.

As also illustrated with reference to FIG. 1, the sealing member 130 may be in contact with a second mirror layer 124 of the mirror layer 120 which may include silicon oxide. The second mirror layer 124 may be stable with respect to an adhesive material included in the sealing member 130, and thus the sealing member 130 may be directly attached to the mirror layer 120 without an additional etching process for the mirror layer 120.

As illustrated in FIG. 12, a portion of the mirror substrate 50 between the neighboring mirror patterns 110 may substantially overlap the emitting region (designated as “E”) of the display unit 300. The mirror layer 120 having a reflectivity less than that of the mirror pattern 110 may overlie the emitting region so that a display property may be realized over the emitting region.

A non-emitting region (designated as “N”) of the display unit 300 may overlap a stacked structure including the mirror layer 120 and the mirror pattern 110 of the mirror substrate 50. The stacked structure may have an oxide-nitride-metal structure so that a reflectivity may be increased. Therefore, a mirror property may be realized over the non-emitting region.

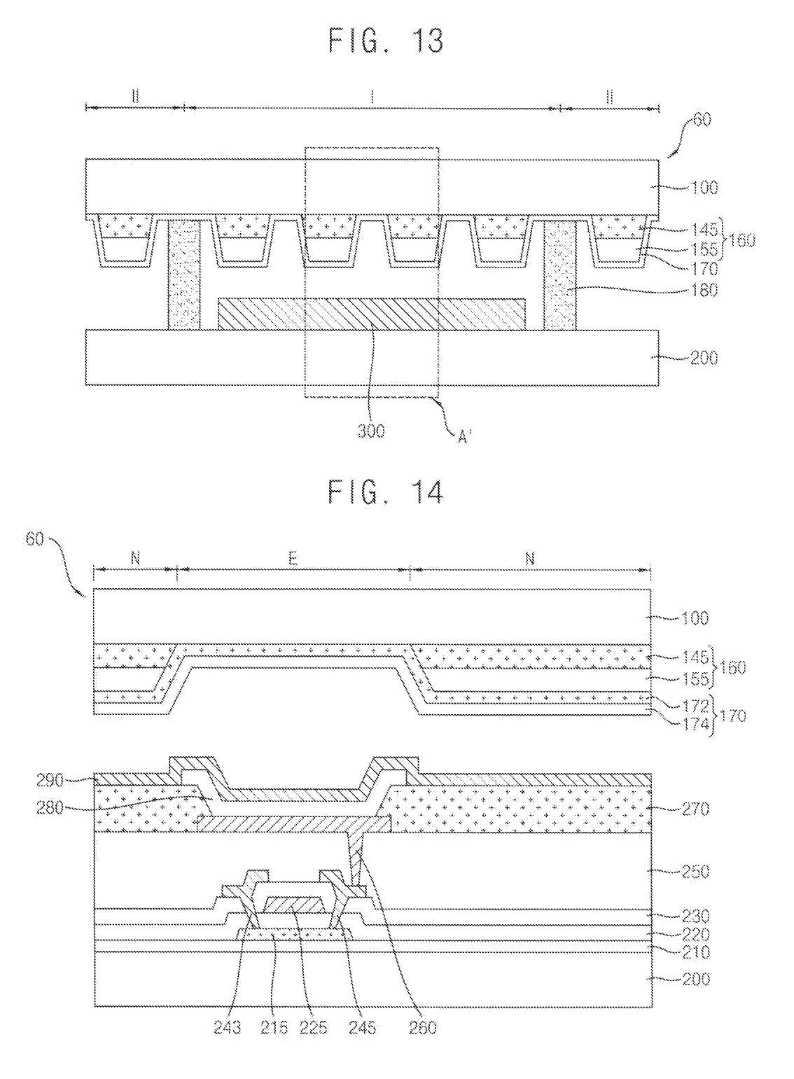

FIG. 13 is a schematic cross-sectional view illustrating a display device in accordance with some example embodiments. FIG. 14 is a partial enlarged view of a portion indicated as “A” in FIG. 13.

The display device illustrated in FIGS. 13 and 14 may have structures and/or constructions substantially the same as or similar to those of the display device illustrated in FIGS. 11 and 12 except for a structure of a mirror pattern. Thus, detailed descriptions on repeated elements and structures are omitted herein.

Referring to FIGS. 13 and 14, the mirror substrate illustrated with reference to FIG. 2 may be utilized as a mirror substrate 60. As described above, the mirror substrate 60 may include mirror patterns 160, each of which may include a first mirror pattern 145 and a second mirror pattern 155 on a transparent substrate 100. A mirror layer 170 may cover the mirror patterns 160, and may be formed continuously on first and second regions I and II of the transparent substrate 100.

The mirror layer may include a first mirror layer 172 in contact with the mirror patterns 160, and a second mirror layer 174 in contact with a sealing member 180.

As illustrated in FIG. 14, the display layer 280 of the display unit 300 may overlap the mirror layer 170 of the mirror substrate 60 which may have a relatively low reflectivity so that a display property or a light emitting property may be realized.

A non-emitting region (designated as “N”, an emitting region may be designated as “E”) of the display unit 300 may overlap both of the mirror pattern 160 and the mirror layer 170. For example, the non-emitting region of the display unit 300 may overlap a quadruple-layered structure having an oxide-nitride-oxide-nitride structure. Thus, a reflectivity on the non-emitting region may be increased due to a refractive index change so that a mirror property may be realized over the non-emitting region.

According to example embodiments of the present inventive concepts, in a manufacture of a mirror substrate, mirror patterns may be formed on a transparent substrate, and a mirror layer covering the mirror patterns may be formed as a multi-layered structure including a silicon nitride layer and a silicon oxide layer. The silicon oxide layer may be mechanically and chemically stable with respect to an adhesive resin material, and thus a sealing member for encapsulating a display device may be directly formed on the silicon oxide layer. Therefore, an etching process for patterning the mirror layer may be omitted.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A mirror substrate, comprising:
a transparent substrate;
a plurality of mirror patterns on the transparent substrate; and
a mirror layer extending continuously on the plurality of the mirror patterns and the transparent substrate, the mirror layer including:
a first mirror layer on the transparent substrate and the mirror patterns, the first mirror layer including silicon nitride; and
a second mirror layer on the first mirror layer, the second mirror layer including silicon oxide.

2. The mirror substrate of claim 1, wherein the mirror patterns include a metal.

3. The mirror substrate of claim 1, wherein each of the mirror patterns includes a dielectric material, and includes a first mirror pattern and a second mirror pattern sequentially disposed on the transparent substrate.

4. The mirror substrate of claim 3, wherein the first mirror pattern includes silicon nitride, and the second mirror pattern includes silicon oxide.

5. The mirror substrate of claim 1, wherein the transparent substrate is divided into a first region and a second region,
the plurality of the mirror patterns are regularly arranged throughout the first region and the second region, and
the mirror layer extends commonly and continuously on the first region and the second region.

6. A method of manufacturing a mirror substrate, comprising:
preparing a transparent substrate including a first region and a second region;
forming mirror patterns distributed throughout the first region and the second region of the transparent substrate;
forming a first mirror layer on surfaces of the transparent substrate and the mirror patterns, the first mirror layer including silicon nitride;
forming a second mirror layer on the first mirror layer, the second mirror layer including silicon oxide; and
forming a sealing member between the first region and the second region such that the sealing member is in contact with the second mirror layer.

7. The method of claim 6, wherein forming the mirror patterns includes:
forming a metal layer on the transparent substrate; and
patterning the metal layer.

8. The method of claim 6, wherein forming the mirror patterns includes:
forming a first dielectric layer including silicon nitride on the transparent substrate;
forming a second dielectric layer including silicon oxide on the first dielectric layer; and
patterning the second dielectric layer and the first dielectric layer.

9. The method of claim 8, wherein the first mirror layer is thinner than each of the first dielectric layer and the second dielectric layer, and the second mirror layer is thinner than each of the first dielectric layer and the second dielectric layer.

10. The method of claim 6, wherein the first mirror layer and the second mirror layer are formed continuously throughout the first region and the second region.

11. A display device, comprising:
a display substrate;
a display unit on the display substrate;
a mirror substrate facing the display substrate with respect to the display unit, the mirror substrate including:
a transparent substrate;
a plurality of mirror patterns on the transparent substrate; and
a mirror layer extending continuously on the plurality of the mirror patterns and the transparent substrate, the mirror layer including a first mirror layer and a second mirror layer sequentially stacked on the transparent substrate and the mirror patterns, the first mirror layer including silicon nitride and the second mirror layer including silicon oxide; and
a sealing member encapsulating the display unit between the display substrate and the mirror substrate, the sealing member being in contact with the second mirror layer.

12. The display device of claim 11, wherein the mirror patterns include a metal.

13. The display device of claim 11, wherein each of the mirror patterns includes a silicon nitride pattern and a silicon oxide pattern sequentially stacked on the transparent substrate.

14. The display device of claim 11, wherein the display unit includes an emitting region and a non-emitting region,
the emitting region overlaps a portion of the mirror layer between neighboring ones of the mirror patterns, and
the non-emitting region overlaps a stacked structure including the mirror layer and each of the mirror patterns.

15. The display device of claim 14, wherein the stacked structure has an oxide-nitride-oxide-nitride structure or an oxide-nitride-metal structure.

16. The display device of claim 14, wherein the emitting region includes an organic emitting layer or a liquid crystal layer.

17. The display device of claim 11, wherein the transparent substrate is divided into a first region and a second region by the sealing member, and the first region overlaps the display unit,
wherein the mirror patterns and the mirror layer are arranged throughout the first region and the second region.

18. The display device of claim 11, wherein the sealing member includes an adhesive resin material.

19. The display device of claim 11, wherein the mirror layer is thinner than each of the mirror patterns.
